(19) United States
(12) Patent Application Publication
(10) Pub. No.: US 2002/0111880 A1
(43) Pub. Date: Aug. 15, 2002

(54) Method of facilitating electronic commerce over a computer network

(75) Inventors: Jack H. Stutts, San Antonio, TX (US); Greg Brakel, San Antonio, TX (US)

Correspondence Address: Richard R. Ruble, JACKSON WALKER L.L.P., Suite 2100, 112 E. Pecan Street, San Antonio, TX, 78205, US

(73) Assignee: Buy And Sell Fast, Inc.

(21) Appl. No.: 10/076,189

(22) Filed: Feb. 14, 2002

Related U.S. Application Data
(60) Provisional application No. 60/268,798, filed on Feb. 14, 2001.

(51) Int. Cl. G06F 17/60

(52) U.S. Cl. 705/26

(57) ABSTRACT

The present invention provides a system and method of facilitating electronic commerce that allows merchants and/or individuals to buy and sell products in a non-auction environment without establishing an individual web site. The present invention provides the buyer with real-time product availability information and immediate purchase consummation. Additionally, the present invention is capable of providing multiple buyers with a shopping party experience. The present invention generates a home show collection of products collection of products for display to each member of the shopping party. In one embodiment, each product in the collection is displayed individually and in a random order to allow each member of the shopping party to experience the feeling of shopping in a conventional store. The present invention is capable of displaying the home show collection according to a predetermined order designed to resemble the order in which the buyer(s) would encounter products on the shelves of a conventional store.

This patent application claims priority from a provisional patent application entitled “A Method for Facilitating Commercial Transactions over a Computer Network,” Serial No. 60/268,798, having a filing date of Feb. 14, 2001.

### FIELD OF THE INVENTION

The present invention relates generally to methods of performing electronic commerce and more particularly, to a method of facilitating commercial transactions over a computer network.

### BACKGROUND OF THE INVENTION

The Internet has emerged as a large community of electronically-connected users located around the world who readily and regularly exchange significant amounts of information. The Internet continues to serve its original purpose of providing access and exchange of information among government agencies, laboratories, and universities for research and education. In addition, the Internet has evolved to serve a variety of interests and forums that extend beyond its original goals.

There is growing interest in electronic commerce, whereby individuals and/or entities can transact business with other individuals and/or entities via interconnected networks, such as the Internet. Electronic commerce offers advantages to both buyers and vendors. With electronic commerce, a buyer may access many more vendors than could be achieved via conventional methods of commerce. Thus, with electronic commerce, buyers can potentially achieve a lower purchase price, as well as a wider selection of goods and/or services. By the same token, electronic commerce affords vendors a larger market place, and access to a larger number of buyers.

Much of the electronic commerce presently conducted between buyers and vendors occurs by the exchange of data in the form of graphics and/or text. Typically, a buyer seeking to purchase goods and/or services electronically initiates the transaction by first establishing a data link with the vendor. For example, if the vendor possesses a web site on the World-Wide Web portion of the Internet, the buyer initially makes a connection via a computer, to an Internet Service Provider. Once connected, the buyer then enters the Universal Resource Locator (URL) associated with the vendor to access that vendor's web site. After the buyer has accessed the vendor's web site, the buyer enters the information needed to complete the transaction.

Although advantageous, electronic commerce is not without drawbacks. First, the process of comparing prices by the buyer can be a tedious one. To compare prices, the buyer must locate each vendor site individually using a search engine or other searching method. The buyer must then investigate each vendor site to locate the price of particular products.

Once the buyer has decided to purchase an item, he or she places an order. If the vendor has the item in stock, the order is affirmed by an electronic mail sent to the buyer's attention. Thus, the buyer does not know if the transaction has taken place until he or she receives an electronic mail or other communication from the vendor.

### SUMMARY OF THE INVENTION

Accordingly, the present invention provides a system and method of facilitating electronic commerce that allows merchants and/or individuals to buy and sell products in a non-auction environment without establishing an individual web site. Specifically, the present invention provides an e-commerce site upon which a plurality of vendors may list products according to a variety of categories. In this manner, the present invention provides each buyer with the opportunity to comparison shop via one internet site.

The present invention provides the buyer with real-time product availability information. By maintaining current records regarding which products are available at any given time, the present invention allows e-commerce transactions to be consummated immediately. Specifically, when a buyer decides to purchase a product that is shown by the system as having an available quantity, the system immediately confirms the sale to both buyer and vendor and provides information for the two parties to conclude the transaction. When an item has been sold out, the system immediately updates each item listing to indicate that the item is no longer available.

The present invention is capable of providing multiple buyers with a shopping party experience. The present invention generates a home show collection of products for display to each member of the shopping party. In one embodiment, each product in the collection is displayed individually and in a random order to allow each member of the shopping party to experience the feeling of shopping in a conventional store. Additionally, the present invention is capable of displaying the home show collection according to a predetermined order designed to resemble the order in which the buyer(s) would encounter products on the shelves of a conventional store.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing, wherein:

FIG. 1 is a component diagram of one embodiment of the present invention.

FIG. 2 is a flow chart illustrating the seller sign-up/product posting process of one embodiment of the present invention.

FIG. 3 is a flow chart illustrating the browsing/purchasing process of one embodiment of the present invention.

FIG. 4 is a flow chart illustrating the shopping party process of one embodiment of the present invention.

### DETAILED DESCRIPTION OF THE INVENTION

The present invention is herein described as a method of facilitating electronic commerce over a computer network from an e-commerce site and as a computer system for facilitating electronic commerce over a network from an e-commerce site.

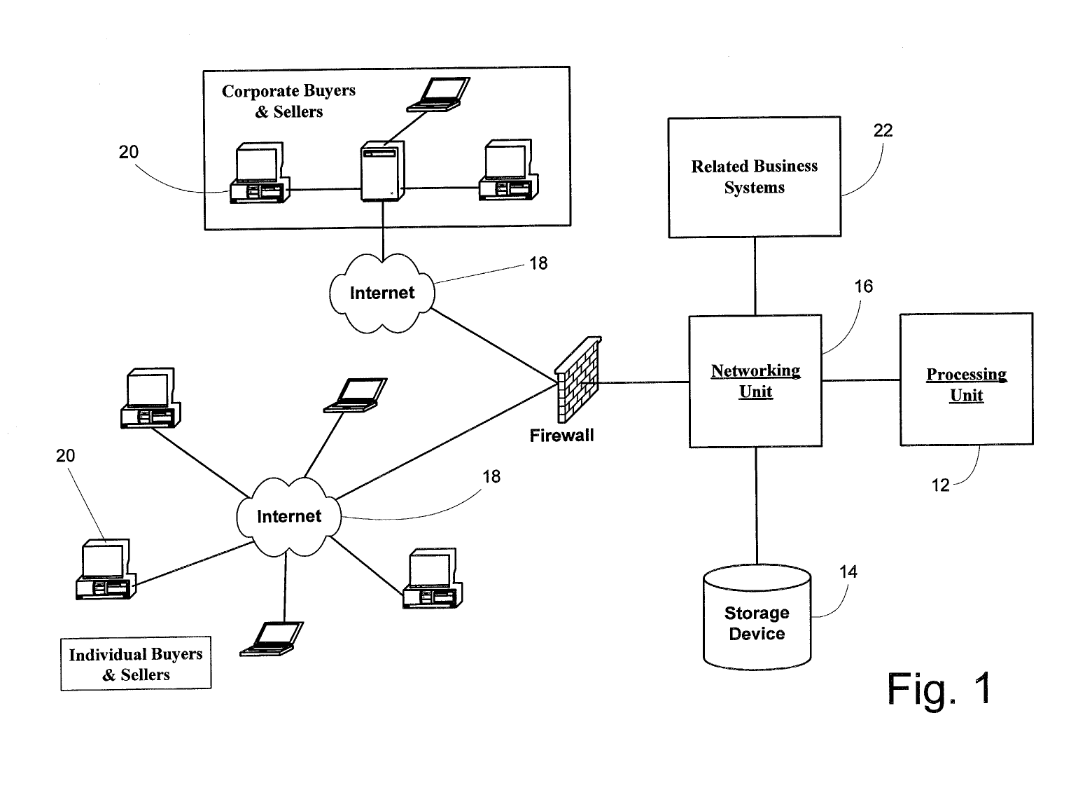

Referring to FIG. 1, the present invention is equipped with a processing unit (12) capable of directing and facilitating commercial activity over a computer network (18). In one embodiment, the processing unit of the present invention is electrically coupled to a storage device (14) capable of storing electronic data. The present invention is further equipped with a networking unit (16) capable of electronic communication over the computer network (18). Specifically, the networking unit is capable of facilitating electronic communication between external users (20) and the processing unit (12) of the present invention. In one embodiment, a CISCO® router or other networking device is utilized by the present invention. In another embodiment, the processing unit (12) of the present invention is coupled to one or more related business systems (22). Specifically, the processing unit (12) is capable of utilizing external enterprise resource planning systems, such as PEOPLESOFT®, for use in executing electronic transactions.

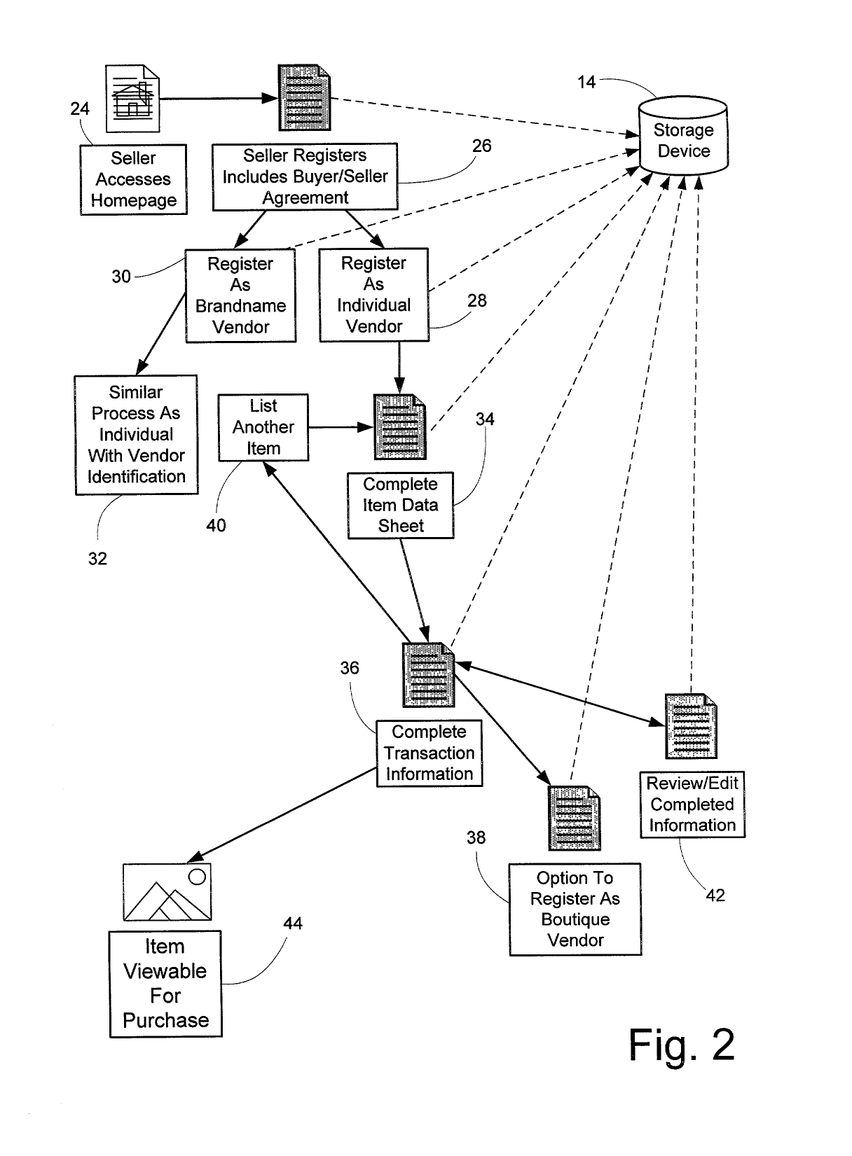

Referring to FIG. 2, merchants and/or individuals wishing to utilize the present invention to display products for sale may access the e-commerce site, or homepage, of the present invention as illustrated by Box (24). Upon accessing the homepage of the present invention, the seller is asked to register, as illustrated by Box (26). Registration requires the seller to provide information from which a unique seller record utilizing a seller identifier may be created. This seller record is stored upon the storage device (14) and is utilized to “match” products displayed upon the e-commerce site of the present invention to individual sellers.

In order to post an item for sale, the seller must agree to abide by the buyer/seller agreement. This agreement provides the seller with rules regarding business conducted through the e-commerce site of the present invention and ensures that each party complies with equitable business practices. Once the seller has agreed to abide by the terms of the agreement, he or she must choose whether to register as an individual vendor or as a brand name vendor, as illustrated by Boxes (28) and (30). Referring to Box (32), the registration process for both vendor types is similar except that brand name vendors are provided with an additional data field. This additional data field allows the seller's brand name to be entered into the system for ultimate display to the consumer. In this manner, the present invention allows each vendor to individually market their products according to specific brand names.

Once the vendor type has been established, the seller is provided with an item data sheet. The item data sheet is designed to illicit specific product information including product category, brand name, cost data, digital photos, incremental cost, quantity available and product age/condition, as illustrated by Box (34). Once this information has been entered, the seller is presented with a transaction information page, as illustrated by Box (36). At this time, the seller is prompted to provide contact information so that the seller may be reached in the event of a product purchase. Additionally, the seller is required to provide payment preference information so that prospective buyers may be informed as to how an item, or items, may be purchased (i.e., check, money order, credit card, etc.).

The seller is given several options upon completion of the transaction information page (36). The seller may approve of the product listing as entered and submit same for display to prospective buyers. The listing is then posted upon the e-commerce site of the present invention such that the item is viewable for purchase, as illustrated by Box (44). The seller may wish to list additional items for sale, as illustrated by Box (40). In this instance, the product posting process described above is repeated for each additional product.

The seller may wish to review each of his or her listings to ensure accuracy. To accomplish this, the present invention provides an edit page (42) having modifiable data fields to allow the seller to review and modify item information. All of the information provided by the seller during the above product listing process is transmitted to the storage device (14) of the present invention for later retrieval. In one embodiment, sellers intending to list 25 or more products upon the e-commerce site of the present invention may choose to register as a boutique vendor, as illustrated by Box (38). The boutique vendor process utilized by the present invention is described in greater detail below.

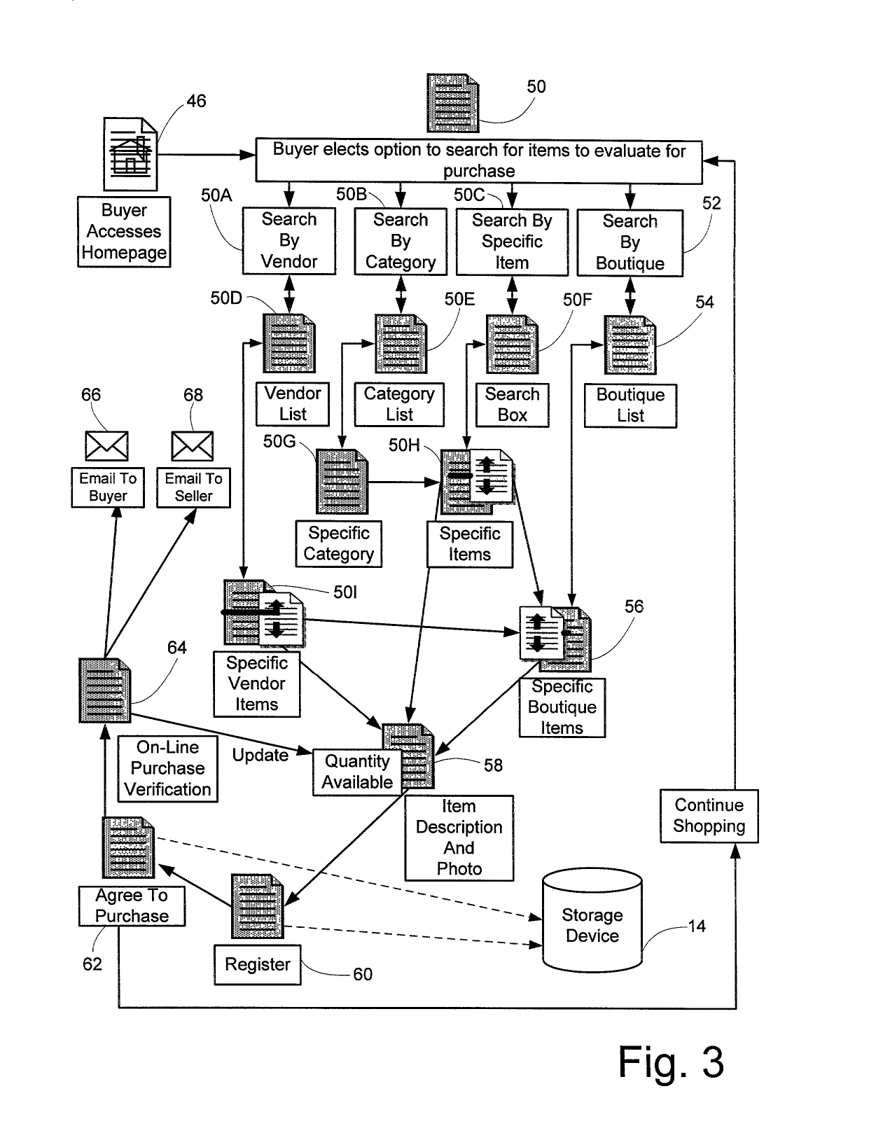

Referring to FIG. 3, buyers wishing to utilize the present invention to browse and/or buy products may access the e-commerce site, or homepage, of the present invention as illustrated by Box (46). Upon accessing the homepage of the present invention, the buyer is presented with a variety of product searching options, as illustrated by Box (50). Conventional searching methods, such as searches utilizing vendor name, product type and item description are provided to the buyer upon the e-commerce site of the present invention as illustrated by Boxes (50A, 50B, 50C, 50D, 50E, 50F, 50G, 50H and 50I). However, the present invention also provides a unique boutique searching option, as illustrated by Box (52). In one embodiment, sellers having 25 or more listed products may request designation as a boutique.

Buyers wishing to search boutique listings are presented with a list of all boutique sellers to choose from, as illustrated by Box (54). The buyer may then review specific items for each boutique seller, as illustrated by Box (56), until the buyer determines which item, if any, to purchase. The real time atmosphere provided by the present invention assists the buyer during his or her selection process. Specifically, each item listing contains the item data sheet information provided by the seller. As a result, the buyer is provided with a written description of the item, the quantity available for each item and one or more digital pictures providing a visual representation of the item, as illustrated by Box (58).

In order to encourage buyer searching upon the e-commerce site of the present invention, no registration is required until the buyer has decided to make a purchase, as illustrated by Box (60). Once the buyer has decided to purchase a product, he or she is prompted to provide buyer identification information. Specifically, registration requires the buyer to provide information from which a unique buyer record utilizing a buyer identifier may be created. This buyer record is stored upon the storage device (14) and is utilized to “match” the buyer with each product being purchased upon the e-commerce site of the present invention. Once the buyer has registered, he or she may place an order upon performance of a single action, as illustrated by Box (62).

Unlike conventional e-commerce sites, the present invention provides for the immediate consummation of electronic commerce upon performance of a single action. This single action may be the click of a button, the speaking of a sound, or any other action capable of conveying the buyer's intent to purchase a product.

Once the buyer has performed this single action, the processing unit (12) of the present invention automatically searches the storage device (14) in order to “match” the buyer with the seller offering the desired product. The processing unit (12) then creates an order file containing buyer and seller information and transmits same to the storage device (14). Upon transmission of the order file to the storage device (14), the processing unit (12) generates a purchase verification message for display upon the e-commerce site of the present invention, as illustrated by Box (64).

From the buyer's perspective, this verification message displayed upon the e-commerce site is instantaneous after he or she has performed the single action described above. Thus, the buyer receives immediate confirmation that the product is available and has been purchased. Once the purchase has been consummated, the processing unit (12) of the present invention sends an email message to both parties to the transaction, as illustrated by Boxes (66) and (68). These email messages remind both parties that the purchase has been consummated and that the buyer/seller agreement rules govern the actions of each party. After each purchase, system records are updated to reflect that the item has been purchased.

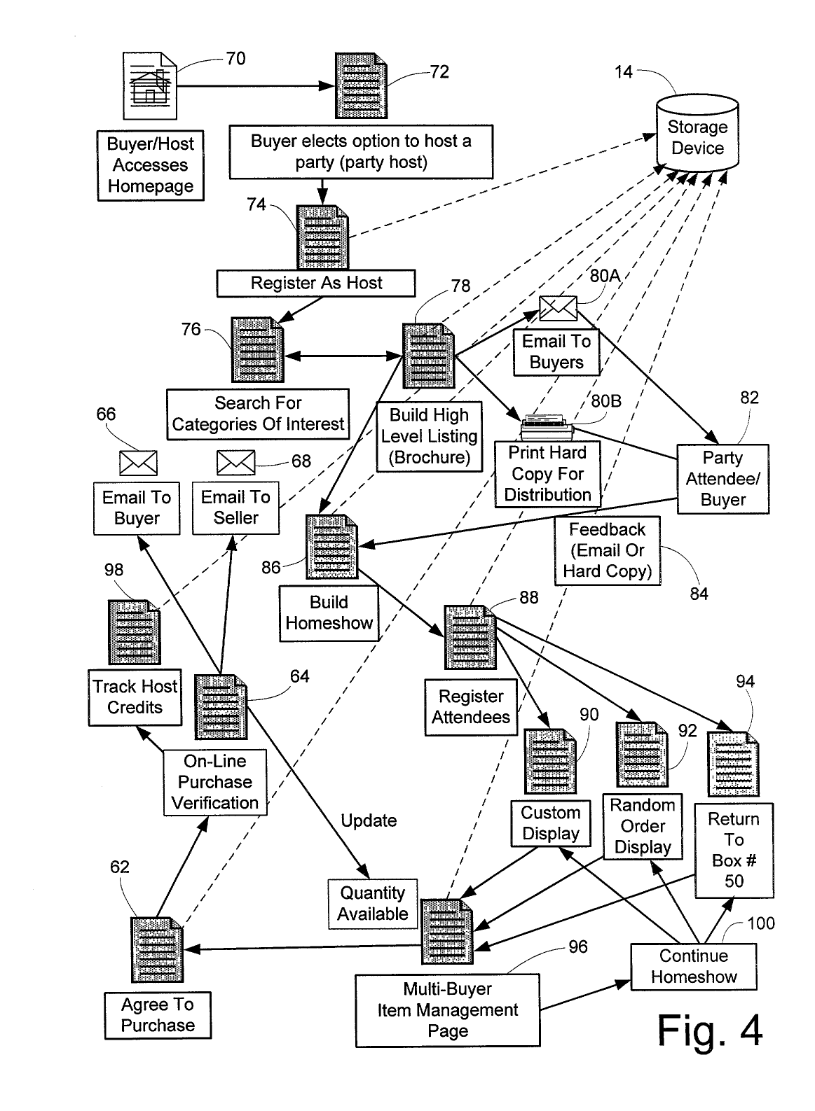

In addition to providing individual or corporate buyers with an enjoyable online shopping experience, the present invention is capable of facilitating one or more shopping parties. Specifically, the present invention is capable of facilitating group shopping in a manner that resembles a conventional TUPPERWARE® party. Referring to FIG. 4, a buyer that wishes to host an online shopping party may access the e-commerce site, or homepage, of the present invention and elect to host a shopping party, as illustrated by Boxes (70) and (72). The buyer then registers as a shopping party host, illustrated by Box (74), and is assigned a unique host identifier.

Once registered, the host searches the e-commerce site of the present invention to determine what product categories would be appropriate for use during the shopping party, as illustrated by Box (76). Utilizing these pre-selected product categories, the present invention creates a high level product listing, or brochure, of proposed product categories, as illustrated by Box (78). This brochure of proposed shopping party product categories may then be sent to each member (82) of the shopping party. In one embodiment of the present invention, the brochure is sent to each party member (82) via email or hard copy, as illustrated by Boxes (80A) and (80B). This feature of the present invention allows each member of the shopping party to comment on the proposed shopping party and provide feedback prior to the date of the shopping party, as illustrated by Box (84).

The present invention allows the host to create a unique home show presentation for use during the shopping party, as illustrated by Box (86). Specifically, the processing unit (12) of the present invention is compatible with a host of presentation applications, such as MICROSOFT POWERPOINT®. Thus, the host can build a home show containing a variety of products for sale as well as accompanying slideshows or other presentation materials. This feature of the present invention allows the host to prepare an entertaining and aesthetically pleasing shopping party experience for each member. Once the home show has been assembled, each member of the shopping party must complete the registration process, as illustrated by Box (88) and described in detail above. Once registration is complete the home show may be displayed to each member of the shopping party.

In one embodiment of the present invention, the shopping party is conducted using a single remote computer system (20) such that the members of the party congregate at the host's residence or place of business. In another embodiment, the members of the shopping party are not physically present in the same location as the host. Instead, the members are electronically connected through a local or wide area network connection such that each member may view the home show items displayed upon the host's computer system. In either case, the members of the shopping party are kept in constant communication such that an enjoyable shopping party atmosphere is maintained.

The host may choose from a variety of options regarding how the shopping party home show is to be displayed. First, the host may choose to display the home show items according to a predetermined order, as illustrated by Box (90). Second, the processing unit of the present invention is capable of displaying each home show item in a manner resembling the order in which a buyer would encounter products on the shelves of a conventional store. This may take the form of a random arrangement or products or may be specifically tailored to resemble a particular brand name store, as illustrated by Box (92). The present invention also allows the display of products obtained through searching performed by the host during the shopping party itself, as illustrated by Box (94).

The present invention allows members of the shopping party to purchase displayed items without substantially interfering with the flow of the home show display items. Specifically, the present invention provides a multi-buyer item management page (96) capable of tracking each member purchase without substantial interruption of the home show display.

For example, Mary decides to purchase a coffee mug shown during the home show item display. Mary need only indicate that she wishes to buy the coffee mug and perform a single action showing her intent to purchase the item. Upon doing so, the buying process described above is automatically initiated as illustrated by Boxes (62), (64), (66) and (68), such that the home show item presentation may be continued, as illustrated by Box (100). In one embodiment, each member of the shopping party is assigned a multi-buyer item management icon that, when clicked upon the host computer, will initiate the buying process, as described above.

In one embodiment, the present invention provides the host with incentives to initiate shopping parties upon the e-commerce site of the present invention, as illustrated by Box (98). Specifically, the host is given credit for purchases made during his or her shopping parties. These credits may be redeemed by the host upon the e-commerce site of the present invention for merchandise.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

We claim:

1. A method of facilitating electronic commerce over a network from an e-commerce site comprising the steps of:
receiving seller information comprising products for sale and seller identification information from a plurality of sellers;
assigning a seller identifier to each of said plurality of sellers;
utilizing said seller identifier, storing said seller information upon a storage device coupled to said e-commerce site;
displaying said products upon said e-commerce site;
receiving buyer information from a plurality of buyers;
assigning a buyer identifier to each of said plurality of buyers;
utilizing said buyer identifier, storing said buyer information upon a storage device coupled to said e-commerce site;
receiving a buyer order for a first product from a remote client system connected to said network, said order being placed upon performance of a single action by a first of said plurality of buyers;
utilizing said buyer identifier and said seller identifier, searching said storage device to obtain 1) said buyer information for said first buyer and 2) said seller information associated with said first product;
creating an order file utilizing said buyer information and said seller information;
transmitting said order file to said storage device, said transmission of said order file to said storage device immediately consummating the sale of said first product to said first buyer; and
displaying a sales confirmation message to said first buyer upon said e-commerce site.

2. The method of claim 1, further comprising the additional step of transmitting said order file to said first seller.

3. The method of claim 1, further comprising the additional step of displaying product availability information upon said e-commerce site.

4. The method of claim 3, further comprising the additional step of updating said product availability information upon transmission of said order file to said storage device.

5. A method of facilitating electronic commerce over a network from an e-commerce site comprising the steps of:
receiving seller information comprising products for sale and seller identification information from a plurality of sellers;
generating a collection of said products for sale utilizing preference information received from a remote host; and
displaying said collection of said products upon said e-commerce site.

6. The method of claim 5, further comprising the additional step of displaying said collection of said products according to a predetermined order.

7. The method of claim 5, further comprising the additional step of displaying said collection of said products according to a random order.

8. The method of claim 5, further comprising the additional step of displaying said collection of products upon said e-commerce website according to a predetermined order, said predetermined order designed to present each of said products of said collection in a manner resembling the order in which a buyer would encounter said products on the shelves of a conventional store.

9. The method of claim 5, further comprising the additional steps of:
receiving collection feedback from one or more remote buyers;
generating a second collection of said products for sale utilizing said collection feedback; and
displaying said second collection of said products upon said e-commerce site.

10. The method of claim 5, further comprising the additional steps of:
assigning a seller identifier to each of said plurality of sellers;
utilizing said seller identifier, storing said seller information upon a storage device coupled to said e-commerce site;
receiving buyer information from a first plurality of buyers;
assigning a buyer identifier to each of said buyers;
utilizing said buyer identifier, storing said buyer information upon a storage device coupled to said e-commerce site;
receiving a buyer order for a first product from a remote client system connected to said network, said order placed by a first of said plurality of buyers upon performance of a single action;
utilizing said buyer identifier and said seller identifier, searching said storage device to obtain 1) said buyer information for said first buyer and 2) said seller information associated with said first product;
creating an order file utilizing said buyer information and said seller information;
transmitting said order file to said storage device, said transmission of said order file to said storage device immediately consummating the sale of said first product to said first buyer; and
displaying a sales confirmation message to said first buyer upon said e-commerce site.

11. The method of claim 10, further comprising the additional step of transmitting said order file to said first seller.

12. A computer system for facilitating electronic commerce over a network from an e-commerce site comprising:
a storage device coupled to said e-commerce site; and
a processing unit coupled to said storage device, said processing unit capable of receiving seller information comprising product information and seller identification information from a plurality of sellers, assigning a seller identifier to each of said plurality of sellers, utilizing said seller identifier, storing said seller information upon a storage device coupled to said e-commerce site, displaying said product information upon said e-commerce site, receiving buyer information from a plurality of buyers, assigning a buyer identifier to each of said plurality of buyers, utilizing said buyer identifier, storing said buyer information upon a storage device coupled to said e-commerce site, receiving a buyer order for a first product from a remote client system connected to said network, said order placed by a first of said plurality of buyers upon performance of a single action, utilizing said buyer identifier and said seller identifier, searching said storage device to obtain 1) said buyer information for said first buyer and 2) said seller information associated with said first product, creating an order file utilizing said buyer information and said seller information, transmitting said order file to said storage device to immediately consummate the sale of said first product to said first buyer and displaying a sales confirmation message to said first buyer upon said e-commerce site.

13. The computer system of claim 12, wherein said processing unit is further defined as being capable of transmitting said order file to said first seller.

14. The computer system of claim 12, wherein said processing unit is further defined as being capable of displaying product availability information upon said e-commerce site.

15. The computer system of claim 12, wherein said processing unit is further defined as being capable of updating said product availability information.

16. The computer system of claim 12, wherein said single action is pushing a button.

17. The computer system of claim 12, wherein said single action is a predetermined sound.

18. A computer system for facilitating electronic commerce over a network from an e-commerce site comprising:
a storage device coupled to said e-commerce site; and
a processing unit coupled to said storage device, said processing unit capable of receiving seller information comprising product information and seller identification information from a plurality of sellers, generating a collection of said products for sale utilizing preference information received from a remote host and displaying said collection of said products upon said e-commerce site.

19. The computer system of claim 18, wherein said processing unit is further defined as being capable of displaying said collection of said products according to a predetermined order.

20. The computer system of claim 18, wherein said processing unit is further defined as being capable of displaying said collection of said products according to a random order.

21. The computer system of claim 18, wherein said processing unit is further defined as being capable of displaying said collection of products upon said e-commerce website according to a predetermined order, said predetermined order designed to present each of said products of said collection in a manner resembling the order in which a buyer would encounter said products on the shelves of a conventional store.

22. The computer system of claim 18, wherein said processing unit is further defined as being capable of receiving collection feedback from one or more remote buyers, generating a second collection of said products for sale utilizing said collection feedback and displaying said second collection of said products upon said e-commerce site.

23. The computer system of claim 18, wherein said processing unit is further defined as being capable of assigning a seller identifier to each of said plurality of sellers, utilizing said seller identifier, storing said seller information upon a storage device coupled to said e-commerce site, receiving buyer information from a plurality of buyers, assigning a buyer identifier to each of said buyers, utilizing said buyer identifier, storing said buyer information upon a storage device coupled to said e-commerce site, receiving a buyer order for a first product from a remote client system connected to said network, said order placed by a first of said plurality of buyers upon performance of a single action, utilizing said buyer identifier and said seller identifier, searching said storage device to obtain 1) said buyer information for said first buyer and 2) said seller information associated with said first product, creating an order file utilizing said buyer information and said seller information, transmitting said order file to said storage device to immediately consummate the sale of said first product to said first buyer and displaying a sales confirmation message to said first buyer upon said e-commerce site.

24. The computer system of claim 23, wherein said processing unit is further defined as being capable of transmitting said order file to said first seller.

25. The computer system of claim 23, wherein said processing unit is further defined as being capable of displaying product availability information upon said e-commerce site.

26. The computer system of claim 25, wherein said processing unit is further defined as being capable of updating said product availability information.
